(19) United States
(12) Patent Application Publication
(10) Pub. No.: US 2013/0064048 A1
(43) Pub. Date: Mar. 14, 2013

(54) TIMEPIECE DIAL, AND TIMEPIECE

(71) Applicant: Koki TAKASAWA, Suwa-shi (JP)

(72) Inventor: Koki TAKASAWA, Suwa-shi (JP)

(73) Assignee: SEIKO EPSON CORPORATION, Tokyo (JP)

(21) Appl. No.: 13/569,515

(22) Filed: Aug. 8, 2012

(30) Foreign Application Priority Data
Sep. 12, 2011 (JP) 2011-198769

(51) Int. Cl. G04B 19/06

(52) U.S. Cl. 368/232

(57) ABSTRACT

To provide a timepiece dial that presents a rich stereoscopic effect, and to provide a timepiece including the timepiece dial, a timepiece dial of the invention has a microlens layer in which a plurality of microlenses are arranged in an orderly fashion when viewed from above, and a decorative layer provided with a design, in which the microlens layer and the decorative layer are superimposed when viewed from above, and the decorative layer has a plurality of regions that are different in the design from each other. Preferably, the decorative layer is provided with a design having a plurality of lines and/or a repeating design having the same arrangement as the microlenses and a pitch that differs from that of the microlenses as the design.

### CROSS-REFERENCE TO RELATED APPLICATIONS

This application claims priority to Japanese Patent Application No. 2011-198769 filed on Sep. 12, 2011. The entire disclosure of Japanese Patent Application No. 2011-198769 is hereby incorporated herein by reference.

### BACKGROUND

1. Technical Field

The present invention relates to a timepiece dial and a timepiece.

2. Background Technology

Timepieces and timepiece dials require functionality as a commercial product and decorative aspects (an aesthetic appearance) as a decorative ornament. Well-known dials for a timepiece are typically composed of a metal material in order to yield an appearance that imparts a sense of luxury. However, with a well-know timepiece dial, the range of the appearance that can be expressed is limited and it is not possible to sufficiently respond to consumer needs.

For example, there is considerable need for a timepiece provided with a dial that presents an appearance having a stereoscopic effect, and a timepiece dial has been proposed in which a plurality of designs and other patterns are formed and layered in alternating fashion with transparent films (see Patent Document 1). However, with such a timepiece dial, a stereoscopic effect having a thickness equal to or greater than that of the timepiece dial cannot be expressed, and it is also difficult to significantly increase the thickness of the timepiece dial itself due to thickness limitations. Therefore, needs such as those described above cannot be sufficiently met. In the particular case of the dial applied to a portable timepiece such as a wristwatch, there is a considerable limitation to the thickness of the timepiece overall, and it is very difficult to achieve an appearance having a rich stereoscopic effect.

Japanese Laid-open Patent Application No. 2-306188 (Patent Document 1) is an example of the related art.

### SUMMARY

### Problems to be Solved by the Invention

An advantage of the invention is to provide a timepiece dial that presents a rich stereoscopic effect, and to provide a timepiece provided with such a timepiece dial.

### Means Used to Solve the Above-Mentioned Problems

The advantages described above are achieved by the invention described below. The timepiece dial of the invention has a microlens layer in which a plurality of microlenses are arranged in an orderly fashion when viewed from above, and a decorative layer provided with a design, in which the microlens layer and the decorative layer are superimposed when viewed from above, and the decorative layer has a plurality of regions that are different in the design from each other. It is thus possible to provide a timepiece dial that presents an appearance having a rich stereoscopic effect. In particular, according to the invention, since the decorative layer has a plurality of regions different in the design from each other, the stereoscopic effect of the timepiece dial can further be strengthened overall.

In the timepiece dial of the invention, preferably, the decorative layer is provided with a design having a plurality of lines and/or a repeating design having the same arrangement as the microlenses and a pitch that differs from that of the microlenses as the design. Thus, a particularly excellent aesthetic appearance and stereoscopic effect can be imparted to a timepiece dial. In the timepiece dial of the invention, preferably, the decorative layer is provided with a repeating design having the same arrangement as the microlenses and a pitch that differs from that of the microlenses, and has regions in which the pitches of the repeating design are different from each other as the plurality of regions. Thus, a particularly excellent aesthetic appearance and stereoscopic effect can be imparted to a timepiece dial.

In the timepiece dial of the invention, preferably, there are a region A in which P_{ML}−P_{R} is a positive value, and a region B provided more outward in a radial direction than the region A in which P_{ML}−P_{R} is a negative value, where P_{ML} [μm] is the pitch of the microlenses and P_{R} [μm] is the pitch of the constituent units of the repeating design. It is thus possible to impart a particularly excellent time visibility (easy to recognize) as well as an excellent aesthetic appearance and stereoscopic effect to a timepiece dial. Specifically, it is possible to achieve a higher level of both practicality as a commercial product and an aesthetic appearance as a decoration.

In the timepiece dial of the invention, preferably, the decorative layer has a region C provided with a repeating design having the same arrangement as the microlenses and a pitch that differs from that of the microlenses, and a region D provided with a design having a plurality of lines. Thus, an excellent aesthetic appearance and stereoscopic effect can be imparted to a timepiece dial. In the timepiece dial of the invention, preferably, the region D is provided more outward in a radial direction than to the region C. It is thus possible to impart a particularly excellent time visibility (easy to recognize) as well as an excellent aesthetic appearance and stereoscopic effect to a timepiece dial. Specifically, it is possible to achieve a higher level of both practicality as a commercial product and an aesthetic appearance as a decoration.

In the timepiece dial of the invention, preferably, a region E serving as time characters and a region F other than the region E have different patterns in the decorative layer. It is thus possible to impart an excellent aesthetic appearance and stereoscopic effect as well as a particularly excellent time visibility to a timepiece dial. In the timepiece dial of the invention, preferably, the decorative layer is provided with a repeating design having the same arrangement as the microlenses and a pitch that differs from that of the microlenses, and the region E has a smaller pitch of the constituent units of the repeating design than the region F. It is thus possible to impart a particularly excellent time visibility (easy to recognize) as well as an excellent aesthetic appearance and stereoscopic effect to a timepiece dial. Specifically, it is possible to achieve a higher level of both practicality as a commercial product and an aesthetic appearance as a decoration.

In the timepiece dial of the invention, preferably, the decorative layer has regions divided by lines extending radially from the axis of hands for indicating the time as the plurality of regions. Thus, a particularly excellent aesthetic appearance and stereoscopic effect can be imparted to a timepiece dial. In the timepiece dial of the invention, preferably, the decorative layer is provided with a repeating design having the same arrangement as the microlenses and a pitch that differs from that of the microlenses, and a region in which P_{ML}−P_{R} is a positive value and a region in which P_{ML}−P_{R} is a negative value where P_{ML} [μm] is the pitch of the microlenses and P_{R} [μm] is the pitch of the constituent units of the repeating design are adjacent. Thus, a particularly excellent aesthetic appearance and stereoscopic effect can be imparted to a timepiece dial.

In the timepiece dial of the invention, preferably, the region provided with a repeating design having the same arrangement as the microlenses and a pitch that differs from that of the microlenses and the region provided with a design having a plurality of lines are adjacent. Thus, a particularly excellent aesthetic appearance and stereoscopic effect can be imparted to a timepiece dial. In the timepiece dial of the invention, preferably, the decorative layer is provided with a repeating design having the same arrangement as the microlenses and a pitch that differs from that of the microlenses, the constituent units of the repeating design are numbers, and each of these numbers is positioned in a region that indicates the time corresponding to the number. It is thus possible to impart a particularly excellent time visibility (easy to recognize) as well as an excellent aesthetic appearance and stereoscopic effect to a timepiece dial. Specifically, it is possible to achieve a higher level of both practicality as a commercial product and an aesthetic appearance as a decoration.

In the timepiece dial of the invention, preferably, the decorative layer has twelve regions divided by the lines extending radially, and numbers from 1 to 12 are provided in the regions. It is thus possible to impart a particularly excellent time visibility (easy to recognize) as well as an excellent aesthetic appearance and stereoscopic effect to a timepiece dial. Specifically, it is possible to achieve a higher level of both practicality as a commercial product and an aesthetic appearance as a decoration.

The timepiece of the invention has the timepiece dial of the invention. It is thus possible to provide a timepiece having a timepiece dial that presents an appearance having a rich stereoscopic effect. In particular, according to the invention, since the decorative layer has a plurality of regions different in the design from each other, the stereoscopic effect of the timepiece dial can further be strengthened overall. According to the invention, it is possible to provide a timepiece dial that presents an appearance having a rich stereoscopic effect, and to provide a timepiece having such a timepiece dial.

### BRIEF DESCRIPTION OF THE DRAWINGS

Referring now to the attached drawings which form a part of this original disclosure:

FIG. 1 is a cross-sectional view of a preferred embodiment of the timepiece dial of the invention;

FIG. 2 is a plan view explaining a relationship between the microlenses constituting the microlens layer and the design constituting the decorative layer;

FIG. 3 is a plan view explaining a relationship between the microlenses constituting the microlens layer and the design constituting the decorative layer;

FIG. 4 is a plan view explaining a relationship between the microlenses constituting the microlens layer and the design constituting the decorative layer;

FIG. 5 is a plan view explaining a relationship between the microlenses constituting the microlens layer and the design constituting the decorative layer;

FIG. 6 is a plan view explaining an arrangement of the plurality of regions constituting the decorative layer;

FIG. 7 is a plan view explaining an arrangement of the plurality of regions constituting the decorative layer;

FIG. 8 is a plan view explaining an arrangement of the plurality of regions constituting the decorative layer;

FIG. 9 is a plan view explaining an arrangement of the plurality of regions constituting the decorative layer; and

FIG. 10 is a partial cross-sectional view of a preferred embodiment of the timepiece (portable timepiece) of the invention.

### DETAILED DESCRIPTION OF EXEMPLARY EMBODIMENTS

Preferred embodiments of the invention will be described below with reference to the accompanying drawings. A preferred embodiment of the timepiece dial of the invention will be described first.

### Timepiece Dial

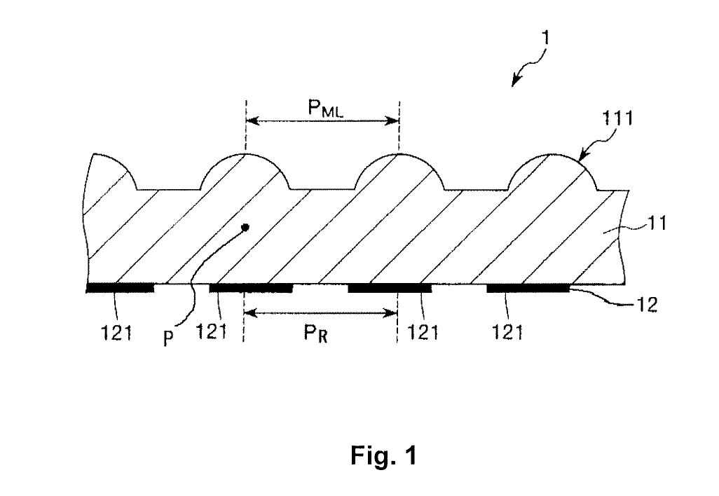

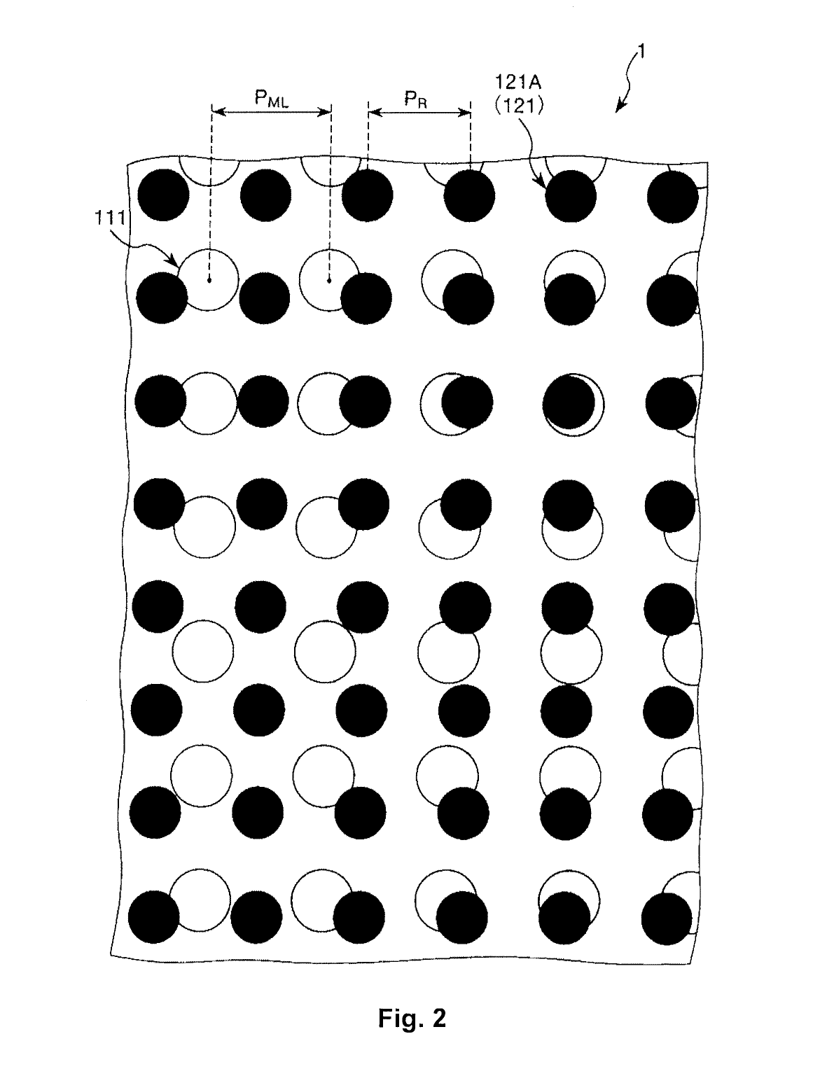

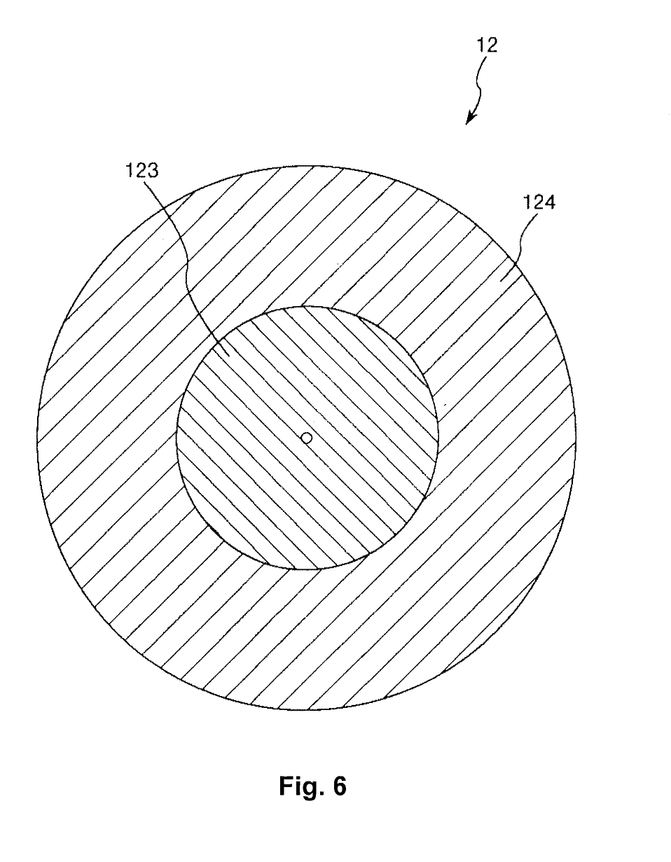

FIG. 1 is a cross-sectional view of a preferred embodiment of the timepiece dial of the invention. FIG. 2 to FIG. 5 are a plan view explaining a relationship between the microlenses constituting the microlens layer and the design constituting the decorative layer. FIG. 6 to FIG. 9 are a plan view explaining an arrangement of the plurality of regions constituting the decorative layer. The drawings referred to in the present specification show part of the configuration in an exaggerated fashion, and they do not reflect actual dimensions etc. correctly. Also, the diagonal lines in FIG. 6 to FIG. 9 are used to clearly differentiate the adjacent regions.

As shown in the drawings, a timepiece dial 1 is provided with a microlens layer 11 and a decorative layer 12 having a design 121. The microlens layer 11 is provided with a plurality of microlenses 111, and the microlenses 111 are arranged in an orderly fashion when the timepiece dial 1 (microlens layer 11) is viewed from above (see FIG. 2 to FIG. 5). The microlens layer 11 and the decorative layer 12 are superimposed when the timepiece dial 1 is viewed from above.

In the decorative layer 12, the design 121 has a plurality of regions different from each other (see FIG. 6 to FIG. 9). As a result of thoroughgoing research, the present inventors found that by configuring the timepiece dial in this manner, it is possible to provide a timepiece dial that makes use of visual optical interference (moire) and presents an appearance having a rich stereoscopic effect. In particular, as a result of thoroughgoing research, the present inventors found that it is possible to provide a timepiece dial that can be discerned by an observer, through sensory misperception, to have a thickness that is equal to or greater than the real thickness of the timepiece dial. In particular, according to the invention, since the decorative layer has a plurality of regions different in the design from each other, the stereoscopic effect of the timepiece dial can further be strengthened overall. The timepiece dial 1 is used such that the microlens layer 11 is arranged closer to the observer side (external surface side) than the decorative layer 12.

### Relationship Between Microlenses Constituting Microlens Layer and Design Constituting Decorative Layer

Hereinafter, a relationship between the microlenses constituting the microlens layer and the design constituting the decorative layer will be explained with specific combination examples (see FIG. 2 to FIG. 5).

### [Microlens Layer]

The microlens layer 11 has a plurality of microlenses 111 arranged in an orderly fashion.

In the configurations shown in FIG. 2 to FIG. 5, the plurality of microlenses 111 are arranged such that, in a case where the centers of microlenses 111 that are adjacent when the timepiece dial 1 is viewed from above are connected by a straight line, a plurality of quadrangles are arranged in an orderly fashion by the straight line. Thus, a particularly excellent aesthetic appearance can be imparted to the timepiece dial 1. In the configurations shown in FIG. 2 to FIG. 5, the quadrangles are squares. Thus, a more particularly excellent aesthetic appearance can be imparted to the timepiece dial 1.

The focal distance of the microlenses 111 is preferably 100 μm or more and 1000 μm or less, and more preferably 150 μm or more and 500 μm or less. Thus, a particularly excellent aesthetic appearance can be imparted to the timepiece dial 1. The focal point is shown as P in the drawing. The pitch P_{ML} of the microlenses 111 (when the timepiece dial 1 is viewed from above) is preferably 50 μm or more and 500 μm or less, and more preferably 60 μm or more and 300 μm or less. Thus, a particularly excellent aesthetic appearance can be imparted to the timepiece dial 1. In the invention, the pitch of the microlenses refers to a distance between the centers of microlenses that are adjacent when the timepiece dial 1 is viewed from above.

The microlens layer 11 is composed of a material having optical transmission properties. In the invention, the phrase “having optical transmission properties” refers to having a property in which at least a portion of light in the visible light region (380 to 780 nm) is transmitted; the transmissivity of light in the visible light region is preferably 50% or more; and the transmissivity of light in the visible light region is more preferably 60% or more. Such light transmissivity can be obtained as follows, for example. By using white fluorescent light (FL20S-D65: a fluorescent light for examination manufactured by Toshiba Corp.) as the light source, an electric current value (x) when power is generated at 1000 lux only by a solar cell (solar battery) having the same shape as the member to be measured (or the timepiece dial) is obtained. Also, an electric current value (Y) when power is generated in the same state except that the member to be measured (or the timepiece dial) is placed on the light source side of the solar cell is obtained. Then, the ratio of Y to X ((Y/X)×100 [%]) obtained as above can be used as light transmissivity.

Examples of the material constituting the microlens layer 11 include various plastics materials and various glass materials, but the microlens layer 11 is preferably composed mainly of a plastic material. Plastic materials generally have excellent moldability (degree of freedom of molding), and can be advantageously used for manufacturing the timepiece dial 1 in various shapes. A microlens layer 11 composed of plastic material is advantageous for reducing the manufacturing cost of the timepiece dial 1. Plastic materials generally have excellent light (visible light) transmissivity, and also have excellent radio wave transmissivity. Therefore, when the microlens layer 11 is composed of a plastic material, the timepiece dial 1 can be advantageously applied to a solar timepiece (a timepiece provided with a solar battery) and a radio timepiece such as that described below. The focus of the description below is an example in which the plate-shaped member 11 is mainly composed of a plastic material. In the invention, the term “mainly” refers to a component present in the greatest amount content among the materials constituting the parts (members) under discussion. The content is not particularly limited, but is preferably 60 wt % or more, more preferably 80 wt % or more, and even more preferably 90 wt % or more of the material constituting the part (member) under discussion.

The plastic material constituting the microlens layer 11 can be any of a variety of thermoplastic resins, thermosetting resins, or the like. Suitable examples thereof include polycarbonate (PC), acrylonitrile-butadiene-styrene copolymer (ABS resin), polymethyl methacrylate (PMMA), and other acrylic resins; polyethylene (PE), polypropylene (PP), and other polyolefin resins; polyethylene terephthalate (PET) and other polyester resins; epoxy resins; urethane resins; and copolymers, blends, polymer alloys, or the like composed mainly of these. Also, one or more of these can be used in combination (e.g., blend resins, polymer alloys, laminates, and the like). It is particularly preferred that the microlens layer 11 be mainly composed of polycarbonate. The microlenses 111 can thereby be endowed with greater transparency, the refractive index of the microlenses 111 can be made optimal, and a particularly excellent aesthetic appearance can thereby be imparted to the timepiece dial 1 overall. A timepiece dial 1 having particularly excellent reliability can be obtained because the strength of the timepiece dial 1 overall can thereby be made particularly excellent, microlenses 111 having greater dimensional precession can be obtained, and unwanted deformations of the microlenses 111 or other anomalies can be more reliably prevented. In the case that the microlens layer 11 is composed of an acrylic resin, a polyester resin, an epoxy resin, or a urethane resin, the microlenses 111 can be more advantageously formed by a printing method (in particular, a droplet discharge method such as an inkjet method).

The microlens layer 11 can include components other than plastic material. Examples of such components include plasticizers, antioxidants, colorants (including various color formers, fluorescent substances, phosphorescent substances, and the like), brighteners, and fillers. For example, when the microlens layer 11 is composed o f a material that includes a colorant, color variations of the timepiece dial 1 can be increased.

The microlens layer 11 can have an essentially uniform composition in each part, or can have a different composition depending on the part. The refractive index (absolute refractive index) of the microlens layer 11 is preferably 1.500 or more and 1.650 or less, and more preferably 1.550 or more and 1.600 or less. Thus, a particularly excellent aesthetic appearance can be imparted to the timepiece dial 1.

In the configuration shown in the drawings, the microlenses 111 are substantially spherical in shape, and are spherical lenses that form a circular shape when viewed from above, but the shape of the microlenses 111 is not particularly limited. For example, it is possible to use a shape that is barrel-shaped (substantially oval shape, elliptical shape), substantially triangular, substantially quadrangular, substantially hexagonal, or the like when viewed from above. The shape and size of the microlens layer) 11 is not particularly limited and is ordinarily determined based on the shape and size of the timepiece dial 1 to be manufactured. In the configuration shown in the drawings, the microlens layer 11 is a flat plate shape, but can also be, e.g., a curved plate shape, or the like.

The microlens layer 11 can be molded using any method; examples of methods for molding the microlens layer 11 include compression molding, extrusion molding, injection molding, photo fabrication, and the 2P method. The microlens layer 11 can be, e.g., a plate-shaped member that does not have microlenses 111, whereon a liquid material containing the constituent material of the microlenses 111 is discharged by the inkjet method or another liquid discharge method to thereby form the microlenses 111. The microlenses 111 can be formed using offset printing, gravure printing, or various other types of printing methods. Microlenses formed using a printing method are advantageous in that the production costs of the microlens layer 11 can be reduced. In the invention, the shape of at least a portion of the microlenses of the microlens substrate is not required to be circular when viewed from above and can be, e.g., oval-shaped. The plurality of microlenses can be independently arranged or adjacently connected.

### [Decorative Layer]

The design constituting the decorative layer 12 can be any as long as optical interference (moire) occurs. However, preferably, the decorative layer 12 is provided with a design having a plurality of lines 121B and/or a repeating design 121A having the same arrangement as the microlenses 111 and a pitch that differs from that of the microlenses 111 as the design 121. Thus, a particularly excellent aesthetic appearance and stereoscopic effect can be imparted to the timepiece dial 1.

In the present specification, “the same arrangement as the microlenses 111” includes the same arrangement having a different size (similarity relationship), and an arrangement compressed or expanded in a predetermined direction in the plane of the decorative layer 12 (for example, such an arrangement that, in a case where connecting the centers of the microlenses 111 that are adjacent when the timepiece dial 1 is viewed from above by a straight line results in a plurality of squares arranged in an orderly fashion by the straight line, connecting the centers of the repeating design 121A that are adjacent when the timepiece dial 1 is viewed from above by a straight line results in a plurality of parallelograms other than a square arranged in an orderly fashion by the straight line).

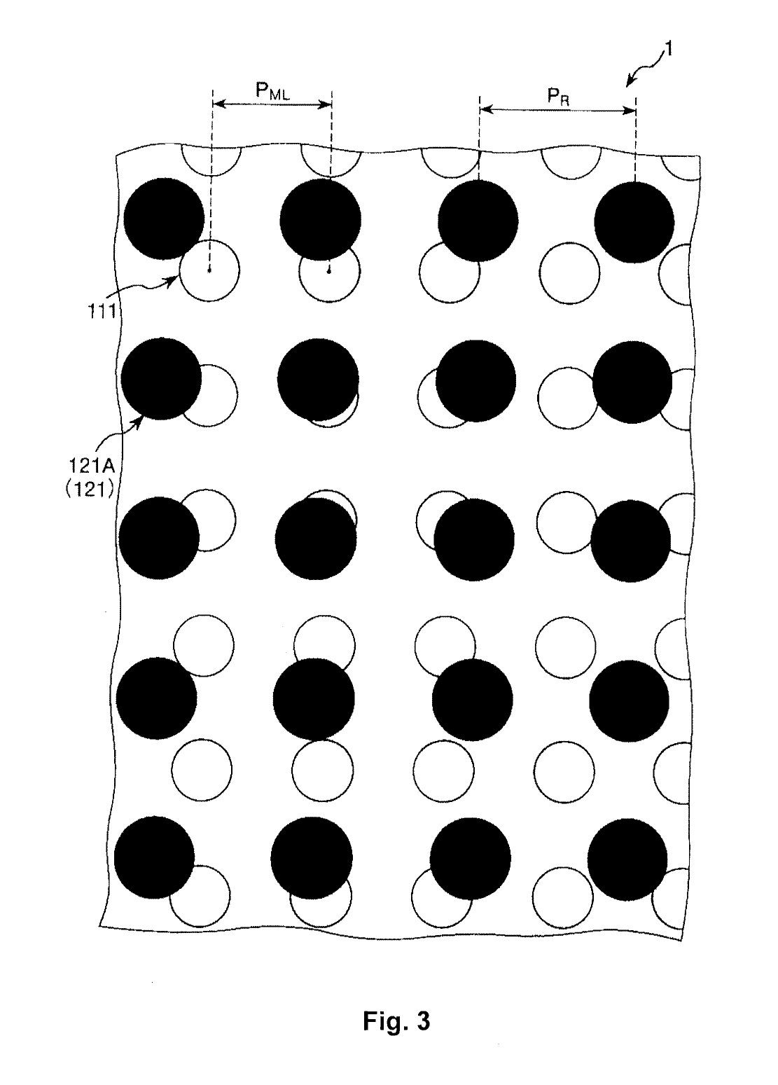

In the configurations shown in FIG. 2 to FIG. 4, the decorative layer 12 is provided with the repeating design 121A having a plurality of constituent units as the design. The repeating design 121A has the same arrangement as the microlenses 111, and the pitch is different from that of the microlenses 111. When the pitch of the repeating design 121A is less than the pitch of the microlenses 111, the design will appear to be recessed. When the pitch of the repeating design 121A is greater than the pitch of the microlenses 111, the design will appear to be floating. Specifically, in the configuration shown in FIG. 2, the design will appear to be recessed, and in the configuration shown in FIG. 3, the design will appear to be floating.

The pitch P_{R} of the adjacent constituent units of the repeating design 121A (the pitch when the timepiece dial 1 is viewed from above) is preferably 40 μm or more and 550 μm or less, and more preferably 50 μm or more and 350 μm or less. Thus, a particularly excellent aesthetic appearance can be imparted to the timepiece dial 1. If the decorative layer has an area where the pitches of the adjacent constituent units are different, the pitches of the adjacent constituent units are preferably in the above-described range with respect to the entire effective region (region where the microlens layer and the decorative layer are superimposed when the timepiece dial is viewed from above and an observer can see when the observer uses the timepiece dial). In the invention, the pitch of the constituent units refers to a distance between the centers of constituent units that are adjacent when the timepiece dial 1 is viewed from above.

The pitch P_{ML} [μm] of the microlenses 111 and the pitch P_{R} [μm] of the constituent units of the repeating design 121A preferably satisfy the relationship of 0.5≦P_{R}/P_{ML}≦1.5, and more preferably satisfy the relationship of 0.7≦P_{R}/P_{ML}≦1.3. It is thus possible to provide the appearance of the timepiece dial 1 with a richer stereoscopic effect and to impart a particularly excellent aesthetic appearance to the timepiece dial 1. If the decorative layer has an area where the pitches of the adjacent constituent units are different, the pitch of the adjacent constituent units preferably satisfies the above relationship with respect to the entire effective region (region where the microlens layer and the decorative layer are superimposed when the timepiece dial is viewed from above and an observer can see when the observer uses the timepiece dial).

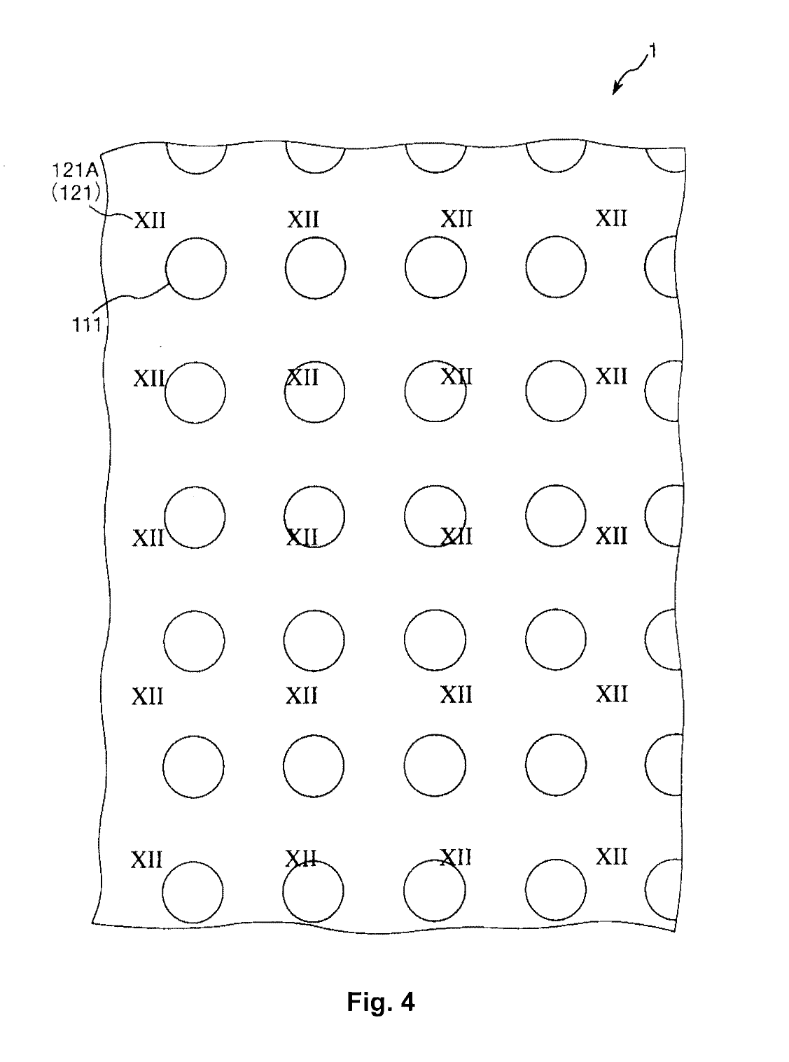

The constituent units of the repeating design 121A form a circular shape in the configurations shown in FIG. 2 and FIG. 3, and form a number in the configuration shown in FIG. 4. However, the shape of the constituent units of the repeating design 121A is not limited to these, and any shape can be used. The constituent units of the repeating design 121A, for example, can form polygonal shapes, oval shapes, star shapes, letters other than numbers, cartoon characters and other more complex shapes. Also, in the configuration shown in FIG. 4, the number constituting the repeating design 121A can be a Roman numeral, an Arabic numeral, a Chinese numeral, and the like.

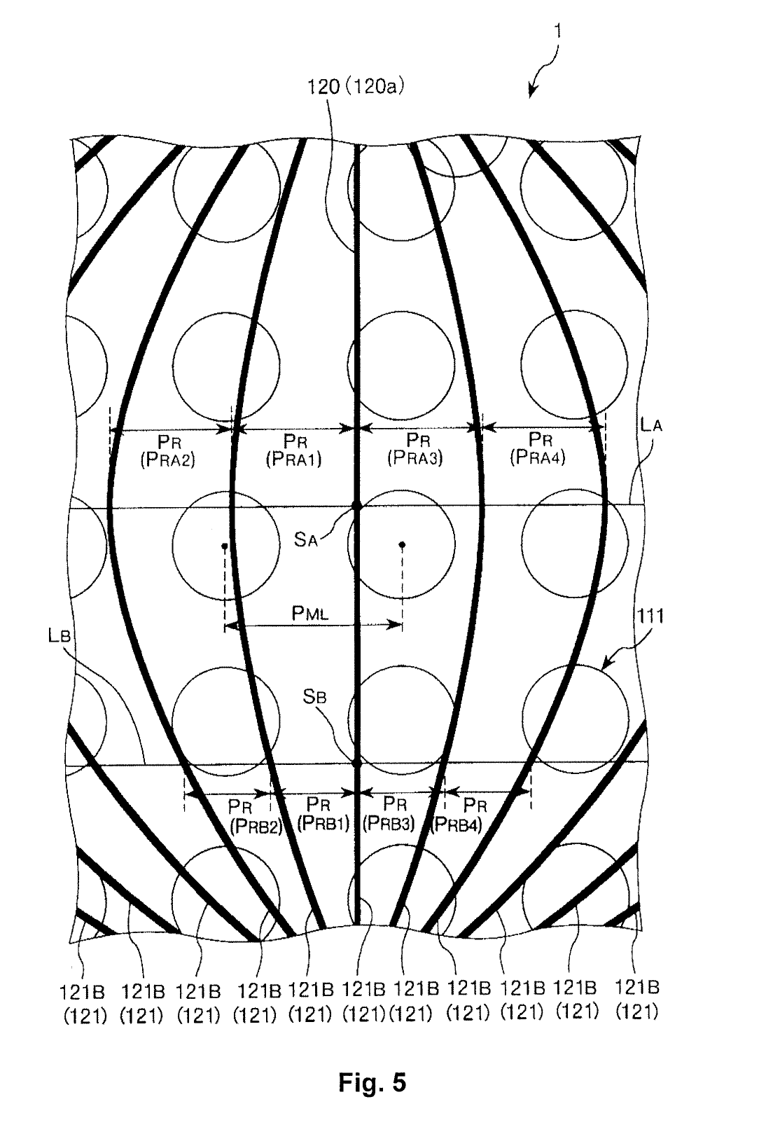

In the configuration shown in FIG. 5, the decorative layer 12 is provided with the design having a plurality of lines 121B as the design. Specifically, in the configuration shown in the drawing, the pitch of the adjacent lines of the design 121B changes along a longitudinal direction of a linear reference line 120. It is thus possible to provide the appearance of the timepiece dial 1 with a richer stereoscopic effect and to impart a particularly excellent aesthetic appearance to the timepiece dial 1. In the configuration shown in the drawing, the reference line 120 is one of the plurality of lines of the design 121B constituting the decorative layer 12. However, the reference line 120 is conceptual, and does not need to be the lines of the design 121B constituting the decorative layer 12.

The amount of the above change of the pitch per unit length (1 cm) of the reference line 120 is preferably 0.4 μm or more and 16 μm or less, and more preferably 0.5 μm or more and 10 μm or less. In other words, the ratio of the above change of the pitch per unit length (1 cm) of the reference line 120 is preferably 0.20% or more and 4.5% or less, and more preferably 0.25% or more and 2.8% or less. It is thus possible to provide the appearance of the timepiece dial 1 with a richer stereoscopic effect and to impart a particularly excellent aesthetic appearance to the timepiece dial 1.

Regarding the plurality of lines of the design 121B, the ratio of the above change of the pitch per unit length of the reference line 120 is preferably the same in each section of the longitudinal direction of the linear reference line 120. For example, the pitches P_{RA1} [μm], P_{RA2} [μm], P_{RA3} [μm], and P_{RA4} [μm] of the lines of the design 121B adjacent in a line L_{A} perpendicular to the reference line 120 passing through a point S_{A} on the reference line 120; and the pitches P_{RB1} [μm], P_{RB2} [μm], P_{RB3} [μm], and P_{RB4} [μm] of the lines of the design 121B adjacent in a line L_{B} perpendicular to the reference line 120 passing through a point S_{B} on the reference line 120 satisfy the relationship of P_{RA1}/P_{RB1}=P_{RA2}/P_{RB2}=P_{RA3}/P_{RB3}=P_{RA4}/P_{RB4}. It is thus possible to provide the appearance of the timepiece dial 1 with a richer stereoscopic effect and to impart a particularly excellent aesthetic appearance to the timepiece dial 1.

The pitches (for example, P_{RA1}, P_{RA2}, P_{RA3}, and P_{RA4}) of the lines of the design 121B adjacent in a line perpendicular to the reference line 120 passing through an arbitrary point on the reference line 120 can be different, but preferably are the same. It is thus possible to impart a particularly excellent aesthetic appearance to the timepiece dial 1. The pitch P_{R} of the adjacent lines of the design 121B (the pitch in a direction perpendicular to the reference line 120 when the timepiece dial 1 is viewed from above) is preferably 40 μm or more and 550 μm or less, and more preferably 50 μm or more and 350 μm or less. Thus, a particularly excellent aesthetic appearance can be imparted to the timepiece dial 1. In the configuration shown in the drawing, the pitch of the adjacent lines of the design 121B changes along a longitudinal direction of the linear reference line 120. In such a case, preferably, the above-described conditions are satisfied in at least part of the region of the timepiece dial 1, and more preferably, the above-described conditions are satisfied in the entire region of the timepiece dial 1.

The pitch P_{ML} [μm] of the microlenses 111 and the pitch P_{R} [μm] of the constituent units of the repeating design 121A preferably satisfy the relationship of 0.5≦P_{R}/P_{ML}≦1.5, and more preferably satisfy the relationship of 0.7≦P_{R}/P_{ML}≦1.3. It is thus possible to provide the appearance of the timepiece dial 1 with a richer stereoscopic effect and to impart a particularly excellent aesthetic appearance to the timepiece dial 1. In the configuration shown in the drawing, the pitch of the adjacent lines of the design 121B changes along a longitudinal direction of the linear reference line 120. In such a case, preferably, the above-described conditions are satisfied in at least part of the region of the timepiece dial 1, and more preferably, the above-described conditions are satisfied in the entire region of the timepiece dial 1.

When the pitch of the adjacent lines of the design 121B is less than the pitch of the microlenses 111, the design will appear to be recessed. When the pitch of the adjacent lines of the design 121B is greater than the pitch of the microlenses 111, the design will appear to be floating. The distance from the lens surface of the microlenses 111 (the upper-side surface in FIG. 1) to the surface of the decorative layer 12 (the upper-side surface in FIG. 1) is preferably 100 μm or more and 1000 μm or less, and more preferably 150 μm or more and 500 μm or less. It is thus possible to provide the appearance of the timepiece dial 1 with a richer stereoscopic effect and to impart a particularly excellent aesthetic appearance to the timepiece dial 1.

In particular, as in the configuration shown in the drawing, in a case where the plurality of microlenses 111 are arranged such that if the centers of microlenses 111 that are adjacent when the timepiece dial 1 is viewed from above are connected by a straight line, a plurality of squares are arranged in an orderly fashion by the straight line, the distance from the lens surface of the microlenses 111 (the upper-side surface in FIG. 1) to the surface of the decorative layer 12 (the upper-side surface in FIG. 1) is preferably 100 μm or more and 1000 μm or less, and more preferably 250 μm or more and 600 μm or less. It is thus possible to provide the appearance of the timepiece dial 1 with a richer stereoscopic effect and to impart a particularly excellent aesthetic appearance to the timepiece dial 1.

The focal distance L₀ [μm] of the microlenses 111 and the distance L₁ [μm] from the lens surface of the microlenses 111 to the surface of the decorative layer 12 preferably satisfy the relationship of 0.5≦L₁/L₀≦1.5, and more preferably satisfy the relationship of 0.6≦L₁/L₀1.4. It is thus possible to provide the appearance of the timepiece dial 1 with a richer stereoscopic effect and to impart a particularly excellent aesthetic appearance to the timepiece dial 1.

The shape and size of the decorative layer 12 is not particularly limited, and is ordinarily determined based on the shape and size of the timepiece dial 1 to be manufactured. In the configuration shown in the drawings, the decorative layer 12 is a flat plate shape, but can also be, e.g., a curved plate shape, or the like. In the configuration shown in the drawing, the microlens layer (microlens substrate) 11 and the decorative layer 12 are in close contact, and thereby the distance between the microlenses 111 and the lines of the design 121B can be kept constant. Thus, a stably excellent aesthetic appearance can be imparted to the timepiece dial 1.

The decorative layer 12 (design) can be composed of any material, examples of which include various pigments, various dyes, and other colorants; and materials containing a metal material. The decorative layer 12 can be composed of a material containing a resin material. It is thus possible to cause the decorative layer 12 to have particularly exceptional adhesion to the microlens layer 11.

The decorative layer 12 can be formed using any method, examples of which include screen printing, gravure printing, pad printing, an inkjet method, and various other printing methods. Thus, the microlens layer (microlens substrate) 11 and the decorative layer 12 can more securely be in contact, and the distance between the microlenses 111 and the lines of the design 121B can more securely be kept constant. Consequently, a stably excellent aesthetic appearance can be imparted to the timepiece dial 1.

Among various printing methods, an inkjet method is particularly preferable. By employing an inkjet method, the above-described effects can be exerted significantly, and a fine design can be formed appropriately. Etching treatment is carried out on a film formed on the substrate, and the remaining portion can be used as a design.

### Arrangement of a Plurality of Regions Constituting Decorative Layer

As described above, in the timepiece dial of the invention, the decorative layer has a plurality of regions that are different in the design from each other. It is thus possible to cause an observer to discern that the timepiece dial has regions of a different depth and the stereoscopic effect of the timepiece dial is extremely excellent.

Hereinafter, an arrangement of the plurality of regions constituting the decorative layer will be explained in detail. The decorative layer 12 is provided with a repeating design having the same arrangement as the microlenses 111 and a pitch that differs from that of the microlenses, and has regions in which the pitches of the repeating design 121A are different from each other as the plurality of regions. For example, the decorative layer 12 can have a region as shown in FIG. 2 and a region as shown in FIG. 3. Thus, a particularly excellent aesthetic appearance and stereoscopic effect can be imparted to the timepiece dial 1.

The decorative layer 12 can have a region (region C) provided with the repeating design 121A (see FIG. 2 to FIG. 4) having the same arrangement as the microlenses 111 and a pitch that differs from that of the microlenses 111, and a region (region D) provided with a design having a plurality of lines (see FIG. 5). For example, the decorative layer 12 can have a region as shown in FIG. 2 and/or FIG. 3, and a region as shown in FIG. 5. Thus, a particularly excellent aesthetic appearance and stereoscopic effect can be imparted to the timepiece dial 1.

Hereinafter, the arrangement of the plurality of regions constituting the decorative layer will be explained in more detail with specific examples by referring to the drawings. The decorative layer 12 has a plurality of regions that are different in the design from each other when viewed from above, and specific examples of the arrangement of the regions in the decorative layer include ones shown in FIG. 6 to FIG. 9.

In the configuration shown in FIG. 6, as the plurality of regions, the decorative layer 12 has a first region 123 (region surrounding the axis of hands indicating the time (hour hand, minute hand, and second hand)) in the vicinity of the center when the timepiece dial 1 is viewed from above, and a second region 124 provided in the outer periphery of the first region 123 (on the outer periphery side of the timepiece dial 1 with respect to the first region 123). In this manner, the decorative layer 12 has a different design with respect to the region (first region 123) in the vicinity of the center when the timepiece dial 1 is viewed from above and the region (second region 124) on the outer periphery side. It is thus possible to impart a particularly excellent time visibility (easy to recognize) as well as an excellent aesthetic appearance and stereoscopic effect to the timepiece dial. Specifically, it is possible to achieve a higher level of both practicality as a commercial product and an aesthetic appearance as a decoration.

In a case where, as shown in FIG. 6, the decorative layer 12 has the region (first region 123) in the vicinity of the center when the timepiece dial 1 is viewed from above and the region (second region 124) on the outer periphery side as the plurality of regions, the repeating design 121A (see FIG. 2 to FIG. 4) is provided in these regions, and preferably P_{ML}−P_{R} is a positive value in the first region (region A) 123, and P_{ML}−P_{R} is a negative in the second region (region B) 124, where P_{ML} [μm] is the pitch of the microlenses 111 and P_{R} [μm] is the pitch of the constituent units of the repeating design 121A. It is thus possible to impart a particularly excellent time visibility (easy to recognize) as well as an excellent aesthetic appearance and stereoscopic effect to the timepiece dial 1. Specifically, it is possible to achieve a higher level of both practicality as a commercial product and an aesthetic appearance as a decoration.

In a case where, as shown in FIG. 6, the decorative layer 12 has the region (first region 123) in the vicinity of the center when the timepiece dial 1 is viewed from above and the region (second region 124) on the outer periphery side as the plurality of regions, the first region 123 is the region (region C) provided with the repeating design 121A (see FIG. 2 to FIG. 4) having the same arrangement as the microlenses 111 and a pitch that differs from that of the microlenses 111, and the second region 124 is the region (region D) provided with the design having a plurality of lines (see FIG. 5). It is thus possible to impart a particularly excellent time visibility (easy to recognize) as well as an excellent aesthetic appearance and stereoscopic effect to the timepiece dial 1. Specifically, it is possible to achieve a higher level of both practicality as a commercial product and an aesthetic appearance as a decoration.

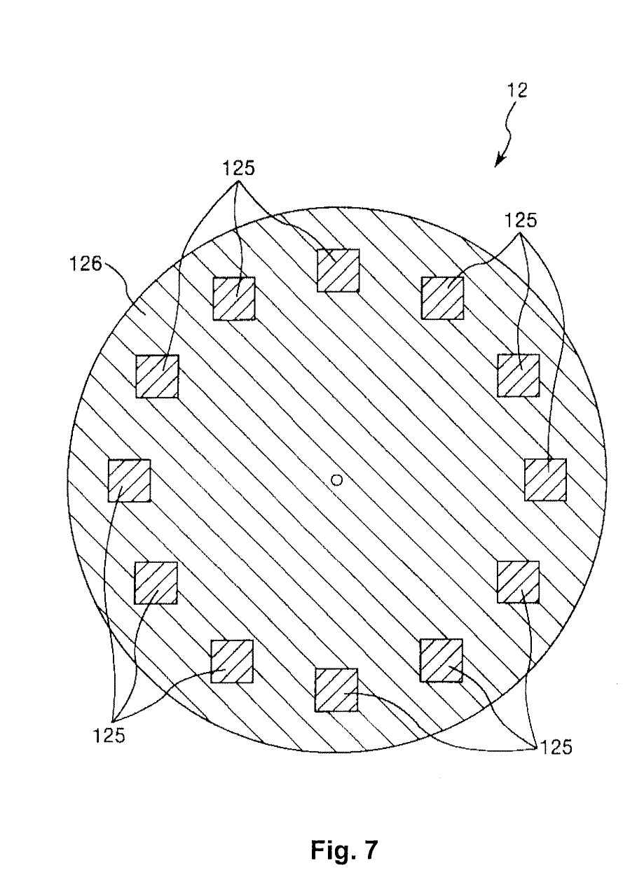

In the configuration shown in FIG. 7, as the plurality of regions, the decorative layer 12 has a region (region E) 125 serving as time characters and a region (region F) 126 other than the region E. It is thus possible to impart a particularly excellent time visibility as well as an excellent aesthetic appearance and stereoscopic effect to the timepiece dial 1. In a case where, as shown in FIG. 7, the decorative layer 12 has the region (region E) 125 serving as time characters and the region (region F) 126 other than the region E, the repeating design 121A (see FIG. 2 to FIG. 4) is provided in these regions, and preferably the region E has a smaller pitch of the constituent units of the repeating design than the region F. It is thus possible to impart a particularly excellent time visibility (easy to recognize) as well as an excellent aesthetic appearance and stereoscopic effect to the timepiece dial 1. Specifically, it is possible to achieve a higher level of both practicality as a commercial product and an aesthetic appearance as a decoration.

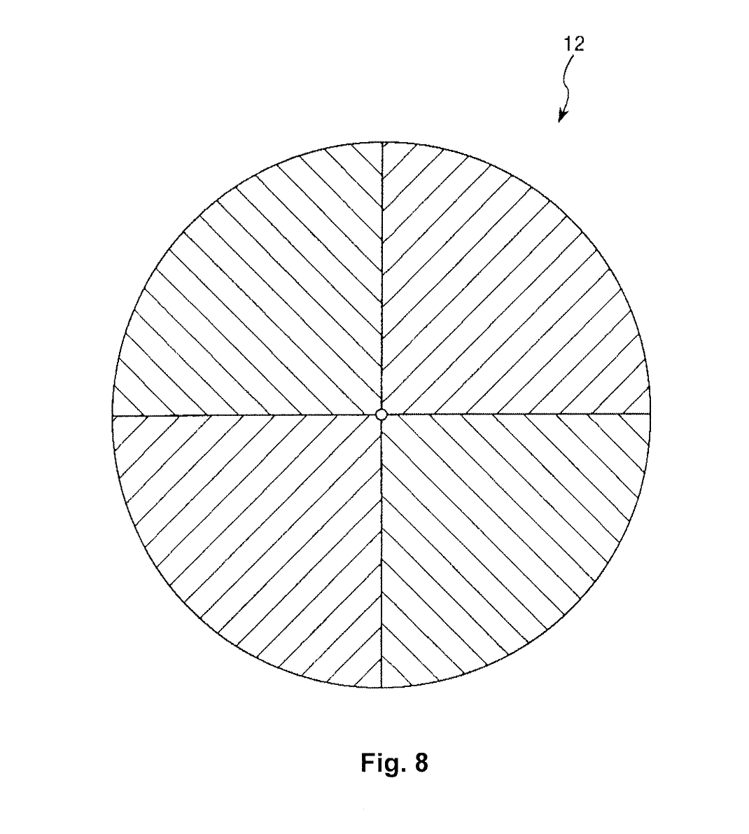

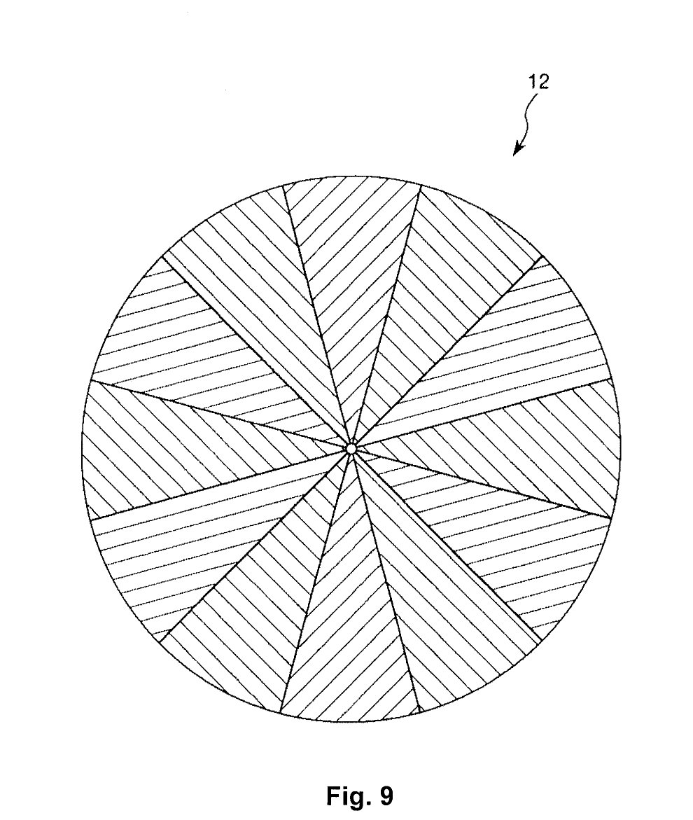

In the configurations shown in FIG. 8 and FIG. 9, the decorative layer 12 has regions divided by lines extending radially from the axis of hands for indicating the time as the plurality of regions. Specifically, in the configuration shown in FIG. 8, the decorative layer 12 has four regions divided (equally-divided) by lines extending radially, and in the configuration shown in FIG. 9, the decorative layer 12 has twelve regions divided (equally-divided) by lines extending radially. Thus, a particularly excellent aesthetic appearance and stereoscopic effect can be imparted to the timepiece dial 1.

In a case where, as shown in FIG. 8 and FIG. 9, the decorative layer 12 has regions divided by lines extending radially from the axis of hands for indicating the time as the plurality of regions, preferably the repeating design 121A (see FIG. 2 to FIG. 4) is provided in these regions, and preferably the region in which P_{ML}−P_{R} is a positive value and the region in which P_{ML}−P_{R} is a negative value where P_{ML} [μm] is the pitch of the microlenses 111 and P_{R} [μm] is the pitch of the constituent units of the repeating design 121A are adjacent. Thus, a particularly excellent aesthetic appearance and stereoscopic effect can be imparted to the timepiece dial 1.

In a case where, as shown in FIG. 8 and FIG. 9, the decorative layer 12 has regions divided by lines extending radially from the axis of hands for indicating the time as the plurality of regions, preferably the region provided with the repeating design 121A (see FIG. 2 to FIG. 4) having the same arrangement as the microlenses 111 and a pitch that differs from that of the microlenses 111 and the region provided with the design 121B having a plurality of lines (see FIG. 5) are adjacent. Thus, a particularly excellent aesthetic appearance and stereoscopic effect can be imparted to the timepiece dial 1.

In a case where, as shown in FIG. 8 and FIG. 9, the decorative layer 12 has regions divided by lines extending radially from the axis of hands for indicating the time as the plurality of regions, the repeating design 121A is provided in these regions, and preferably the constituent units of the repeating design 121 A are numbers, and these numbers are positioned in a region that indicates the time corresponding to the number (see FIG. 4). It is thus possible to impart a particularly excellent time visibility (easy to recognize) as well as an excellent aesthetic appearance and stereoscopic effect to the timepiece dial 1. Specifically, it is possible to achieve a higher level of both practicality as a commercial product and an aesthetic appearance as a decoration.

In a case where, as shown in FIG. 8 and FIG. 9, the decorative layer 12 has twelve regions divided by lines extending radially from the axis of hands for indicating the time as the plurality of regions, preferably numbers from 1 to 12 are provided in these regions. It is thus possible to impart a particularly excellent time visibility (easy to recognize) as well as an excellent aesthetic appearance and stereoscopic effect to the timepiece dial 1. Specifically, it is possible to achieve a higher level of both practicality as a commercial product and an aesthetic appearance as a decoration.

The timepiece dial 1 is preferably applied to a portable timepiece (e.g., a wristwatch). Portable timepieces are timepieces having a particular requirement for thinness, and in accordance with the invention, the stereoscopic effect of the timepiece dial can be made sufficiently excellent while the timepiece dial is made sufficiently thin. In other words, the effects of the invention can be more dramatically demonstrated in a case where the timepiece dial of the invention is applied to a portable timepiece.

### Timepiece

Described next is the timepiece of the invention provided with the timepiece dial of the invention described above. The timepiece of the invention has the timepiece dial of the invention described above. As described above, the timepiece dial of the invention presents an appearance with rich stereoscopic effect; is particularly capable of being discerned by an observer, through sensory misperception, to have a thickness that is equal to or greater than the real thickness of the timepiece dial; and has excellent decorative characteristics (an excellent aesthetic appearance). In particular, according to the invention, since the decorative layer has a plurality of regions different in the design from each other, the stereoscopic effect of the timepiece can further be strengthened overall. Excellent optical transmission properties can be imparted to the overall timepiece dial 1 while an excellent appearance such as that described above can be ensured by the selection of the materials of the decorative layer 12, and the like. Accordingly, the timepiece of the invention provided with such a timepiece dial can sufficiently satisfy the requirements of a solar timepiece. It is possible to use known components other than the timepiece dial constituting the timepiece of the invention (the timepiece dial of the invention). An example of the configuration of the timepiece of the invention is described below.

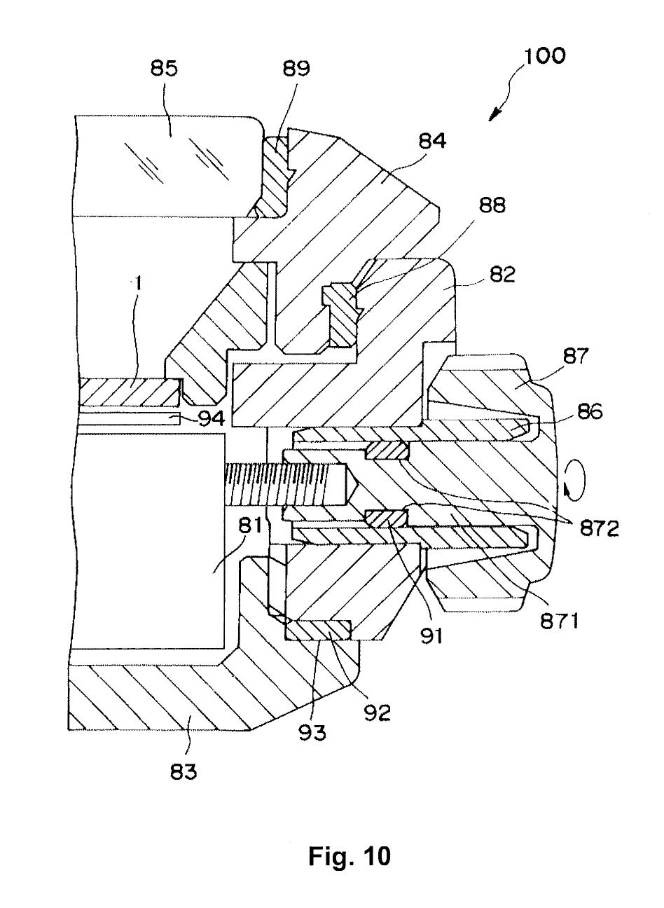

FIG. 10 is a cross-sectional view of a preferred embodiment of the timepiece (portable timepiece) of the invention. The wristwatch (portable timepiece) 100 of the present embodiment is provided with a case body (case) 82, a case back 83, a bezel (edge) 84, and a glass plate (cover glass) 85, as shown in FIG. 10. Also accommodated inside the case 82 are the timepiece dial 1 of the invention as described above, a solar battery 94, a movement 81, and hands (indicator; not shown) and the like. The timepiece dial 1 is provided between the solar battery 94 and the glass plate (cover glass) 85, and the microlens layer 11 is arranged so as to face the glass plate (cover glass) 85 side.

The glass plate 85 is ordinarily composed of transparent glass, sapphire, or the like having high transparency. The aesthetic properties of the timepiece dial 1 of the invention can thereby be sufficiently demonstrated, and a sufficient amount of light can be allowed to be incident on the solar battery 94. The movement 81 drives the hands using the electromotive force of the solar battery 94. Although not shown in FIG. 10, there are provided inside the movement 81, e.g., an electric double layer capacitor for storing the electromotive force of the solar battery 94, a lithium-ion secondary battery, a crystal oscillator as a time reference source, a semiconductor integrated circuit for generating a drive pulse for driving the timepiece on the basis of the oscillating frequency of the crystal oscillator, a step motor for driving the hands in one-second increments on the basis of the drive pulse, a train wheel mechanism for transmitting the movement of the step motor to the hands, and other components.

The movement 81 is provided with an antenna (not shown) for receiving radio waves, and has a function for performing time adjustment or the like using the received radio waves. The solar battery 94 has a function for converting light energy into electric energy. The electric energy converted by the solar battery 94 is used for driving the movement and for other purposes. The solar battery 94 has, e.g., a p-i-n structure in which a p-type impurity and an n-type impurity are selectively introduced into non-single crystal silicon thin films, and an i-type non-single crystal silicon thin film having a low impurity concentration is provided between the p-type non-single crystal silicon thin film and the n-type non-single crystal silicon thin film.

A stem pipe 86 is fitted into and secured to the case 82, and a shaft part 871 of a crown 87 is rotatably inserted into the stem pipe 86. The case 82 and bezel 84 are secured by a plastic gasket 88, and the bezel 84 and glass plate 85 are secured by a plastic gasket 89. The case back 83 is fitted (or threaded) onto the case 82, and a ring-shaped rubber gasket (case back gasket) 92 is intermediately inserted in a compressed state into these joining parts (seal parts) 93. This configuration fluid-tightly seals the joining parts, and a waterproof function is obtained.

A groove 872 is formed in the outer periphery of the crown 87 at a midway point of the shaft part 871, and a ring-shaped rubber gasket (crown gasket) 91 is fitted into the groove 872. The rubber gasket 91 is in close contact with the internal peripheral surface of the stern pipe 86, and is compressed between the internal peripheral surface and the inner surface of the groove 872. This configuration fluid-tightly seals the crown 87 and the stem pipe 86, and a waterproof function is obtained. When the crown 87 is rotatably operated, the rubber gasket 91 rotates together with the shaft part 871, and slides in the peripheral direction while in close contact with the internal peripheral surface of the stern pipe 86. Among various types of timepieces, a watch (wristwatch) such as that described above particularly needs to be made thinner. Therefore, the invention can be more advantageously applied in that the timepiece dial is made thinner and an excellent aesthetic appearance is obtained.

In the description above, a wristwatch (portable timepiece) as a solar radio wave timepiece was described as an example of a timepiece, but the invention can also be similarly applied to portable timepieces other than a wristwatch, a fixed timepiece, a wall timepiece, and various other types of timepieces. The invention can also be applied to solar timepieces excluding solar radio wave timepieces, radio wave timepieces excluding solar radio wave timepieces, and any other timepiece. Preferred embodiments of the invention are described above, but the invention is not limited to the description above.

For example, with the timepiece dial and the timepiece of the invention, the configuration of each part can be substituted with any configuration that demonstrates the same function, and any configuration can be added. An example of such an addition is a printed part formed by various printing methods. In the embodiments described above, at least one layer can be provided to the surface of the microlens layer and/or the decorative layer. Such a layer can be removed when, e.g., the timepiece dial enters service or at another time.

In the embodiments described above, as a typical case, the plurality of microlenses are arranged such that, in a case where the centers of microlenses that are adjacent when the timepiece dial is viewed from above are connected by a straight line, a plurality of quadrangles (in particular, squares) are arranged in an orderly fashion by the straight line. However, the arrangement of the microlenses is not limited to this. For example, the plurality of microlenses can be arranged such that a plurality of triangles (in particular, equilateral triangles) are arranged in an orderly fashion by the straight line.

In the embodiments described above, as a typical case, the design constituting each region of the decorative layer is a design having a plurality of lines and/or a repeating design having the same arrangement as the microlenses and a pitch that differs from that of the microlenses. However, the design constituting each region of the decorative layer is not limited to these. In the embodiments described above, as typical cases of a combination of the plurality of different regions that the decorative layer has, a combination of a region with a design having a plurality of lines and a region with a repeating design having the same arrangement as microlenses and a pitch that differs from that of microlenses, a combination of regions with a repeating design having a different pitch, and a combination of regions with a repeating design having constituent units of a different shape are described. However, a combination of the plurality of different regions is not limited to these.

In the embodiments described above, as a typical case, when the decorative layer has a region with a design having a plurality of lines, the pitch of the adjacent lines of the design changes along a longitudinal direction of a linear reference line in the region. However, the plurality of lines of the design can be provided in parallel. Also, the plurality of lines of the design are not limited to ones arranged in an orderly fashion, but can be ones arranged in a random fashion.

In the configuration shown in FIG. 5, the pitch of the adjacent lines of the design gradually decreases from the center of the timepiece dial (center when viewed from above) toward the outer periphery (directions of three o'clock and nine o'clock). However, the pitch of the adjacent lines of the design can gradually increase from the center of the timepiece dial (center when viewed from above) toward the outer periphery (directions of three o'clock and nine o'clock). Also, in the configuration shown in FIG. 5, the decorative layer has a group of lines (design having a plurality of lines) based on a single linear reference line. However, the decorative layer can have a plurality of groups of lines (for example, a group of lines based on a first reference line and a group of lines based on a second reference line).

In the configurations shown in FIG. 8 and FIG. 9, the decorative layer has four or twelve regions divided by lines extending radially from the axis of hands for indicating the time. However, the number of the regions divided by lines extending radially can be other than these. In the configurations shown in FIG. 8 and FIG. 9, the decorative layer is equally-divided (having the same center angle) by lines extending radially, and the divided regions have the same area. However, the lines extending radially are not limited to ones at equal intervals, and the divided regions can have a different area.

In the embodiments described above, as a typical case, the microlenses are provided in the same pattern (at a predetermined pitch) on the microlens layer, but the microlens layer can have a plurality of regions in which the arrangement pattern of the microlenses is different. In the embodiments described above, as a typical case, the microlens layer is provided with convex lenses as the microlenses, but the microlenses can be concave lenses as long as the focal points are connected on the surface side on which the decorative layer is provided.

In the embodiments described above, as a typical case, the microlens layer provided with the microlenses and the decorative layer are in close contact, but the microlens layer and the decorative layer do not need to be in close contact. For example, the timepiece dial can have a microlens substrate and a substrate provided with a decorative layer, which are spaced apart with a predetermined distance.

What is claimed is:

1. A timepiece dial comprising:
a microlens layer in which a plurality of microlenses are arranged in an orderly fashion when viewed from above; and
a decorative layer provided with a design, wherein
the microlens layer and the decorative layer are superimposed when viewed from above, and the decorative layer has a plurality of regions that are different in the design from each other.

2. The timepiece dial according to claim 1, wherein the decorative layer is provided with a design having a plurality of lines and/or a repeating design having the same arrangement as the microlenses and a pitch that differs from that of the microlenses as the design.

3. The timepiece dial according to claim 1, wherein the decorative layer is provided with a repeating design having the same arrangement as the microlenses and a pitch that differs from that of the microlenses, and has regions in which the pitches of the repeating design are different from each other as the plurality of regions.

4. The timepiece dial according to claim 3, further comprising a region A in which P_{ML}−P_{R} is a positive value, and a region B provided more outward in a radial direction than the region A in which P_{ML}−P_{R} is a negative value, where P_{ML} [μm] is the pitch of the microlenses and P_{R} [μm] is the pitch of the constituent units of the repeating design.

5. The timepiece dial according to claim 1, wherein the decorative layer has a region C provided with a repeating design having the same arrangement as the microlenses and a pitch that differs from that of the microlenses, and a region D provided with a design having a plurality of lines.

6. The timepiece dial according to claim 1, wherein the region D is provided more outward in a radial direction than the region C.

7. The timepiece dial according to claim 1, wherein a region E serving as time characters and a region F other than the region E have different patterns in the decorative layer.

8. The timepiece dial according to claim 1, wherein the decorative layer is provided with a repeating design having the same arrangement as the microlenses and a pitch that differs from that of the microlenses, and the region E has a smaller pitch of the constituent units of the repeating design than the region F.

9. The timepiece dial according to claim 1, wherein the decorative layer has regions divided by lines extending radially from the axis of hands for indicating the time as the plurality of regions.

10. The timepiece dial according to claim 9, wherein the decorative layer is provided with a repeating design having the same arrangement as the microlenses and a pitch that differs from that of the microlenses, and a region in which P_{ML}−P_{R} is a positive value and a region in which P_{ML}−P_{R} is a negative value where P_{ML} [μ] is the pitch of the microlenses and P_{R} [μm] is the pitch of the constituent units of the repeating design are adjacent.

11. The timepiece dial according to claim 9, wherein the region provided with a repeating design having the same arrangement as the microlenses and a pitch that differs from that of the microlenses and the region provided with a design having a plurality of lines are adjacent.

12. The timepiece dial according to claim 9, wherein the decorative layer is provided with a repeating design having the same arrangement as the microlenses and a pitch that differs from that of the microlenses, the constituent units of the repeating design are numbers, and these numbers are positioned in a region that indicates the time corresponding to the number.

13. The timepiece dial according to claim 12, wherein the decorative layer has twelve regions divided by the lines extending radially, and numbers from 1 to 12 are provided in the regions.

14. A timepiece comprising the timepiece dial according to claim 1.
